(19) United States
(12) Patent Application Publication
(10) Pub. No.: US 2026/0158688 A1
(43) Pub. Date: Jun. 11, 2026

(54) RAZOR CARTRIDGE

(71) Applicant: DORCO CO., LTD., Seoul (KR)

(72) Inventors: Da Woon HAN, Seoul (KR); Ji Hun KI, Seoul (KR); Sang Hun PARK, Seoul (KR)

(21) Appl. No.: 19/179,411

(22) Filed: Apr. 15, 2025

Related U.S. Application Data
(63) Continuation of application No. PCT/KR2024/007020, filed on May 23, 2024.

(30) Foreign Application Priority Data
May 26, 2023 (KR) 10-2023-0068696
Jul. 21, 2023 (KR) 10-2023-0095160
May 13, 2024 (KR) 10-2024-0062673

(51) Int. Cl. B26B 21/22; B26B 21/40; B26B 21/44; B26B 21/52

(52) U.S. Cl. CPC B26B 21/222; B26B 21/4018; B26B 21/443; B26B 21/521

(57) ABSTRACT

A razor cartridge is proposed. The cartridge may include at least one razor blade having a cutting edge. The cartridge may also include a razor blade housing accommodating the razor blade in the longitudinal direction and including a razor blade window exposing at least a part of the cutting edge. The cartridge may further include a first area positioned in front of the razor blade housing and having a longitudinal length gradually increasing from the rear to the front. The cartridge may further include a second area positioned in front of the first area and having a longitudinal length gradually decreasing from the rear to the front.

### CROSS REFERENCE TO RELATED APPLICATIONS

This is a continuation application of International Patent Application No. PCT/KR2024/007020 filed on May 23, 2024, which claims priority to Korean patent application No. 10-2023-0068696 filed on May 26, 2023, Korean patent application No. 10-2023-009516 filed on Jul. 21, 2023, and Korean patent application No. 10-2024-0062673 filed on May 13, 2024, contents of each of which are incorporated herein by reference in their entireties.

### BACKGROUND

### Technical Field

The present disclosure relates to a razor cartridge, and more specifically, to a razor cartridge that accommodates at least one razor blade.

### Description of Related Technology

Generally, a razor is a product designed to cut body hair such as fine hair, beard, etc., on the face or body. It consists of a razor handle for gripping and a razor cartridge equipped with at least one razor blade that comes into contact with the skin to perform shaving.

During the shaving process, the razor causes irritation to the user's skin due to frictional force occurring between the razor cartridge and the skin, cutting force applied to the body hair to cut the hair, and external force applied to areas of skin with wounds.

### SUMMARY

One aspect is a razor cartridge that reduces irritation to the user's skin during the shaving process.

Another aspect is a razor cartridge that can perform multiple functions on the user's skin during shaving by increasing the size of the functional components.

The aspects of the present disclosure are not limited to those described herein, and other aspects not mentioned will be clearly understood by those skilled in the art from the following description.

Another aspect is a razor cartridge that includes at least one blade having a cutting edge, a blade housing that accommodates the blade in a longitudinal direction and includes a blade window through which at least a portion of the cutting edge is exposed, a first region located in front of the blade housing, the longitudinal length of which gradually increases from the rear to the front, and a second region located in front of the first region, the longitudinal length of which gradually decreases from the rear to the front.

Other details of the disclosure are included in the detailed description and the accompanying drawings.

According to the embodiments of the disclosure, the effects are at least as follows.

It is possible to reduce the irritation to the user's skin during the shaving process.

Various functional components can be included in the razor cartridge.

Uniform pressure can be applied from the front to the rear of the razor cartridge, allowing for a more even shave.

The effects of the present disclosure are not limited to the examples provided above, and more various effects are included within this specification.

### BRIEF DESCRIPTION OF THE DRAWINGS

FIG. 1 is a side view showing a razor assembly according to an embodiment of the present disclosure.

FIG. 2 is a top view of a razor cartridge according to an embodiment of the present disclosure.

FIG. 3 is a perspective view of a razor cartridge according to an embodiment of the present disclosure.

FIG. 4 is a cross-sectional view taken along line I-I′ shown in FIG. 3.

FIG. 5 is a top view of a razor cartridge according to an embodiment of the present disclosure.

FIG. 6 is an enlarged view of a portion of the area shown in FIG. 5.

### DETAILED DESCRIPTION

Recently, with the increasing interest in skincare, the demand for razor cartridges that include functional elements capable of providing positive benefits to the skin while reducing the irritation caused during shaving has been increasing. Examples of such functional elements include lubricating bands, guard rubbers, combs, heating elements, exfoliating components, and lubricant dispensing units.

On the other hand, in the case of a razor cartridge, it is necessary to ensure that shaving is possible in curved areas such as the cheeks and chin or narrow areas such as under the nose and sideburns, so it is difficult to manufacture it above a certain size. Therefore, there is a need for a design of a razor cartridge that can effectively reduce skin irritation while efficiently arranging functional elements within the limited size of the razor cartridge.

The advantages and features of the present disclosure, and how to achieve them, will become apparent by referring to the embodiments described in detail below in conjunction with the accompanying drawings. However, the present disclosure is not limited to the embodiments disclosed below and can be implemented in various different forms. These embodiments are provided so that this disclosure will be thorough and complete, and will fully convey the scope of the disclosure to those skilled in the art, and the present disclosure will be defined only by the scope of the claims.

In addition, the embodiments described in this specification will be explained with reference to ideal cross-sectional and/or schematic views of the present disclosure. Therefore, the shapes of the illustrations may be modified by manufacturing techniques and/or tolerances. Also, each component in the figures may be exaggerated or reduced for ease of explanation. Throughout the specification, the same reference numerals refer to the same components.

Moreover, in describing the components of the embodiments of the present disclosure, terms like first, second, i), ii), a), b), etc. may be used. These terms are only for distinguishing one component from another, and do not inherently indicate the nature, order, or sequence of the components. When an element is referred to as being “comprising” or “including” another element, it does not exclude the presence of additional elements unless explicitly stated otherwise.

Hereinafter, the present disclosure will be described with reference to the drawings that illustrate the razor cartridge and the razor assembly including the same according to the embodiments of the present disclosure.

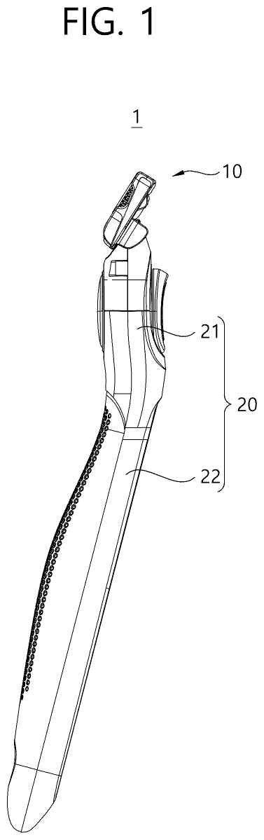

FIG. 1 is a side view showing a razor assembly according to an embodiment of the present disclosure.

Referring to FIG. 1, a razor assembly 1 according to an embodiment of the present disclosure includes a razor cartridge 10 and a razor handle 20 to which the razor cartridge 10 is connected. According to the embodiment, the razor cartridge 10 may be detachably connected to the razor handle 20. Additionally, according to the embodiment, the razor cartridge 10 may be configured to pivot within a certain angle range relative to the razor handle 20. Alternatively, according to the embodiment, the razor cartridge 10 may be configured not to pivot relative to the razor handle 20.

The razor handle 20 includes a handle body 22 and a handle head 21.

The handle body 22 may extend from the handle head 21 and is the part gripped by the user.

The handle head 21 is provided at one end of the handle body 22 and is detachably connected to the razor cartridge 10, supporting the attached razor cartridge 10 pivotably. For this purpose, a connector (not shown) for connecting the razor cartridge 10 and the razor handle 20 may be provided between the end of the razor cartridge 10 and the handle head 21.

The connector may be configured to allow the razor cartridge 10 to be detachably connected to the razor handle 20 or to allow the razor cartridge 10 to pivot relative to the razor handle 20. However, it is not limited to this, and the connector may be configured not to provide at least one of the functions of detachable coupling and pivotable coupling between the razor cartridge 10 and the razor handle 20. If the connector provides the pivot function, the connector may be configured to pivot with either the razor cartridge 10 or the razor handle 20.

Hereinafter, the razor cartridge 10 according to the embodiments of the present disclosure will be described.

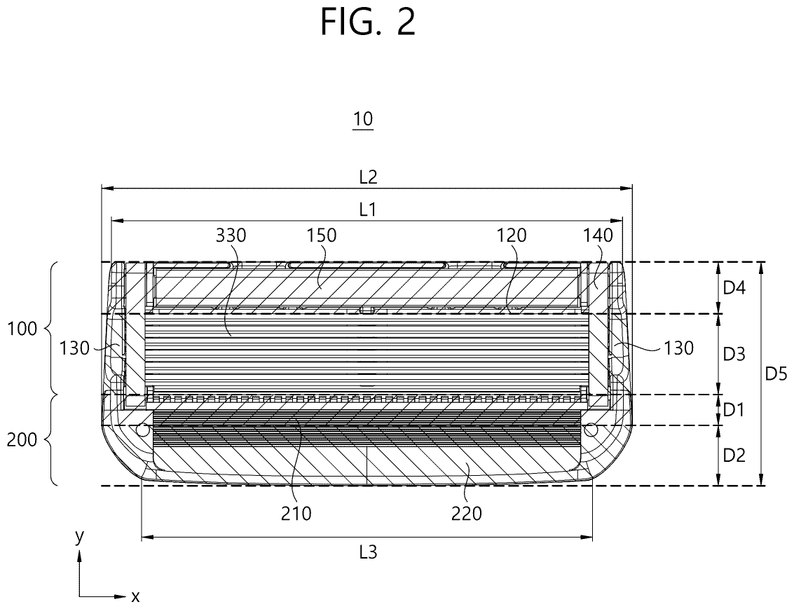

FIG. 2 is a top view of a razor cartridge according to an embodiment of the present disclosure.

Referring to FIG. 2, the razor cartridge (10) according to an embodiment of the present disclosure may include a blade housing (100), a functional unit (200), and blades (300).

The blade housing (100) can incorporate a blade window (120) and a lubricating band (150).

The blade housing (100) is configured to longitudinally accommodate at least one blade (300), and each blade (300) can be arranged transversely in a row within the blade housing (100) so that the cutting edges are parallel along the longitudinal direction.

Here, “longitudinal” refers to the length direction of the razor cartridge (10), which, for instance, can be parallel to the x-axis in FIG. 2. Additionally, “transverse” refers to the width direction of the razor cartridge (10), which could be parallel to the y-axis in FIG. 2. Furthermore, in this specification, the terms “front” and “rear” are defined based on the shaving direction. For example, the front could be the negative direction of the y-axis in FIG. 2, and the rear could be the positive direction of the y-axis in FIG. 2.

The upper surface of the razor cartridge (10) may contact or face the user's skin during the shaving process.

Each blade (300) may be housed within the blade housing (100) with its cutting edge facing forward. Although FIG. 2 shows an example including six blades (300) within the blade housing (100), the number of blades (300) can vary according to the embodiment.

The blade housing (100) may include a blade window (120) that allows at least part of the cutting edges of the blades (300) to be exposed on the upper surface of the razor cartridge (10).

Additionally, the blade housing (100) may be equipped with a lubricating band (150) located at the rear of the blade window (120) to add a lubrication function to the skin for a smoother feeling during shaving. The lubricating band (150) can be positioned at the central rear of the blade housing (100).

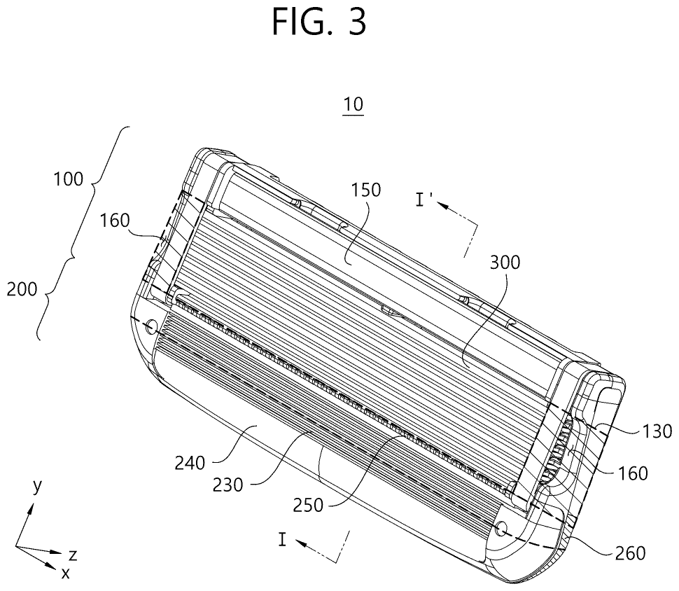

Furthermore, the position of the lubricating band (150) does not need to be exclusively occupied by the lubricating band (150) alone; it could also include one or more components that perform different or similar functions such as an elastic guard, guard pins, a comb, a scrubber, soap, etc., as a first to third functional units (refer to features 230, 240, 250 in FIG. 3).

The functional unit (200) can interact directly with the user's skin during shaving, providing features that enhance the shaving experience. The functional unit (200) may be positioned at the front of the blade window (120). However, the disclosure is not limited to this, as the functional unit (200) can also be located at the sides and/or rear of the blade window (120).

The functional unit (200) may include a first region (210), which has a longitudinal length that gradually increases from the rear to the front, and a second region (220), located in front of the first region (210), where the longitudinal length gradually decreases from the rear to the front.

The first region (210) may include a section where the rate of increase in the longitudinal length is approximately constant, meaning the first region (210) may include straight sections at both longitudinal ends. Here, the rate of increase (or decrease) in the longitudinal length refers to the increase (or decrease) in the longitudinal length relative to the same increase in the transverse length as it extends from the rear to the front.

However, the disclosure is not limited to this, and the first region (210) may include sections where the rate of increase in the longitudinal length is not constant. In such cases, the longitudinal ends of the first region (210) may include curved sections.

Additionally, the second region (220) may include sections where the rate of decrease in the longitudinal length is not constant. For instance, the second region (220) may include a section where the rate of decrease in the longitudinal length continuously increases as it extends from the rear to the front. In this case, the second region (220) may include outwardly convex curved sections at both longitudinal ends.

The second region (220), being located at the front of the razor cartridge (10), can serve as the actual starting point of shaving. Therefore, the curved sections formed at both longitudinal ends of the second region (220) can smooth the shaving experience and reduce the irritation transmitted to the skin.

However, the disclosure is not limited to this, and the second region (220) may include sections where the rate of decrease in the longitudinal length continuously decreases or remains constant. In these cases, the second region (220) may include outwardly concave curved sections or straight sections at both longitudinal ends.

The rate of increase in the longitudinal length of the first region (210) and the rate of decrease in the longitudinal length of the second region (220) may be independent of each other.

Moreover, the magnitude of the rate of increase in the longitudinal length in the first region (210) may be smaller than the magnitude of the rate of decrease in the longitudinal length in the second region (220). However, the disclosure is not limited to this configuration.

Furthermore, the blade housing (100) may also include a third region (130) located on both longitudinal sides of the blade window (120) and a fourth region (140) located at the rear of the blade window (120). According to an embodiment of the disclosure, the third region (130) may include a section where the rate of increase in the longitudinal length is roughly constant. Here, the rate of increase in the longitudinal length of the third region (130) is calculated by summing the increments of the longitudinal components formed on both longitudinal sides of the blade window (120).

However, the disclosure is not limited to this, and the third region (130) may include sections where the rate of increase in the longitudinal length continuously increases or is not constant. In such cases, the third region (130) may include straight sections or curved sections at both longitudinal ends.

According to an embodiment of the present disclosure, the fourth region (140) may include a section where the rate of increase in the longitudinal length is approximately constant.

However, the disclosure is not limited to this, as the fourth region (140) may also include sections where the rate of increase in the longitudinal length continuously increases or where the rate of increase is not constant. In such cases, the fourth region (140) may include straight sections or curved sections at both longitudinal ends.

The rate of increase in the longitudinal length of the first region (210) and the third region (130) may be the same at the boundary between the first region (210) and the third region (130). Therefore, the boundary area between the first region (210) and the third region (130) can be more smoothly connected, which may improve the shaving experience.

Additionally, the rate of increase in the longitudinal length of the third region (130) and the fourth region (140) may be the same at the boundary between these regions. Thus, the boundary area between the third region (130) and the fourth region (140) can be more smoothly connected, further enhancing the shaving experience.

The rates of increase in the longitudinal length of the first region (210), the third region (130), and the fourth region (140) may be identical. That is, the first region (210), the third region (130), and the fourth region (140) may include extended straight sections along both longitudinal sides. In such cases, the longitudinal ends of the blade housing (100) may include continuous straight sections extending from the rearmost part of the blade housing (100) to the rearmost part of the second region (220). The two straight sections formed at the longitudinal ends of the blade housing (100) may become closer together as they extend from the front to the rear.

The first region (210) and/or the second region (220), having relatively large longitudinal lengths, may cause the skin at the front to stretch across a relatively wide area when in contact with the blade housing (100) during shaving. The skin stretched by the first region (210) and/or the second region (220) may subsequently come into contact with the third region (230) and/or the fourth region (240). In this case, since the third region (230) and/or the fourth region (240) have relatively small longitudinal lengths, the skin may contact the razor cartridge (10) over a relatively narrow area. This may result in a slightly contracted skin shape towards the center of the blade housing (100). Such a skin configuration could correspond in part to the converging straight sections of the blade housing (100). Consequently, this reduction in interference between the contracted skin and the blade housing (100) can provide an improved shaving experience during use.

Referring to FIG. 2, the rearmost longitudinal length (L1) of the blade housing (100) can be shorter than the second longitudinal length (L2) at the boundary between the first region (210) and the second region (220).

Additionally, the third longitudinal length (L3) at the very front of the second region (220) can be shorter than the second longitudinal length (L2).

Consequently, the second longitudinal length (L2) may be the maximum longitudinal length of the razor cartridge (10).

According to an embodiment of this disclosure, the third longitudinal length (L3), which is the initial contact point on the razor cartridge (10) with the user's skin during shaving, is relatively shorter than the second longitudinal length (L2), which contacts the user's skin later during the shaving process.

Therefore, the razor cartridge (10) of this embodiment can first contact the skin in a narrower area (including the third longitudinal length L3) before the hair is cut, and progressively contact the skin in a relatively wider area (including the second longitudinal length L2), thereby reducing irritation to the user's skin during shaving.

Moreover, this embodiment of the razor cartridge (10) can reduce the irritation to the skin during the shaving process, allowing for a smoother shaving experience. To enhance this effect, the third longitudinal length (L3) can be formed shorter than the first longitudinal length (L1).

Furthermore, as the second longitudinal length (L2) increases, the areas of the first region (210) and the second region (220) can also increase. This allows for the functional unit (200) formed on the first region (210) and the second region (220) to deliver more functions to the user's skin.

Additionally, the razor cartridge (10) can have the second longitudinal length (L2) as the maximum longitudinal length, with the longitudinal length progressively decreasing rearward from this point to the first longitudinal length (L1).

Typically, during shaving, the user stretches the skin using features like the elastic guard and guard pins formed at the front of the razor cartridge (10), and moves the razor cartridge (10) in the direction of shaving. Since the stretching of the skin occurs through the front area of the razor cartridge (10), the force transmitted to the skin is strongest near the frontmost blade and weakens toward the rear. This results in uneven pressure on the user's skin during the shaving process, making effective shaving difficult.

However, according to the present disclosure's razor cartridge (10), since the first longitudinal length (L1) is shorter than the second longitudinal length (L2), the longitudinal width of the razor cartridge (10) gradually decreases from the frontmost part of the first region (210) to the rearmost part of the blade housing (100). Therefore, even if the force transmitted to the skin decreases from the front to the rear during the shaving process, the longitudinal width of the razor cartridge (10) also decreases, thus equalizing the pressure distributed across the user's skin through the entire razor cartridge (10). This allows the user to perform an effective shave.

In one embodiment of the present disclosure, the second longitudinal length (L2) of the razor cartridge (10) may range between 33 mm and 50 mm, with a preferred range of 37 mm to 46 mm. The first longitudinal length (L1) may range from 32 mm to 49 mm, preferably between 36 mm and 45 mm, and the third longitudinal length (L3) may be between 27 mm and 42 mm, ideally between 31 mm and 39 mm.

The ratio of the second transverse length (D2) of the second region (220) to the first transverse length (D1) of the first region (210) can range from 1 to 2, preferably from 1.25 to 1.92, more preferably from 1.36 to 1.84, and most preferably between 1.44 and 1.76. By making the second transverse length (D2) relatively larger than the first transverse length (D1), the area of the second region (220) where the longitudinal width decreases can be increased, thereby reducing skin irritation and improving the shaving experience.

Additionally, the second transverse length (D2) can range from 3.6 mm to 5.5 mm, ideally between 4.1 mm and 5.1 mm. If the second transverse length (D2) is too large, it could excessively increase the size of the razor cartridge (10). Conversely, if the second transverse length (D2) is too small, it could reduce the area of the second region (220), diminishing the effect of reducing skin irritation.

The transverse length of the blade window (120) and the third transverse length (D3) of the third region (130) can range from 4.4 mm to 6.7 mm, preferably between 5.2 mm and 6.0 mm.

The fourth transverse length (D4) of the fourth region (140) can be between 2.9 mm and 4.5 mm, ideally between 3.3 mm and 4.1 mm.

Consequently, the overall transverse length (D5) of the razor cartridge can range from 14 mm to 21 mm, ideally between 15 mm and 19 mm.

The ratio of the area of the functional unit (200) to the total surface area of the top surface of the razor cartridge (10) can range from 0.5 to 0.85, ideally between 0.6 and 0.75.

Here, the area refers to the two-dimensional area measured based on the top view of the razor cartridge, such as shown in FIG. 2.

This disclosure enhances the shaving experience by increasing the ratio of the area of the functional unit (200) to the total area of the razor cartridge (10), thus delivering more functions to the user's skin.

Additionally, the ratio of the areas of the first region (210), the second region (220), the third region (130), and the fourth region (140) to the area of the blade window (120) can range from 1.1 to 5, preferably between 1.5 and 3.

Such embodiments of the razor cartridge (10) can incorporate larger areas for the first region (210), the second region (220), the third region (130), and the fourth region (140) to perform various functions on the skin, with further details on these functions to be discussed later.

FIG. 3 is a perspective view of a razor cartridge according to an embodiment of the present disclosure.

Referring to FIG. 3, the functional unit (200) may include a first functional unit (230), a second functional unit (240), and a third functional unit (250).

The first functional unit (230) is located at the boundary between the first region (210) and the second region (220), and partially on the first region (210). It can include one or more configurations performing various functions such as an elastic guard, guard pins, a lubricating band, a comb, or a scrubber. According to FIG. 3, the first functional unit (230) may be equipped with an elastic guard that helps stretch the skin to facilitate hair cutting during shaving. This elastic guard can be located at the longitudinal center of the boundary between the first region (210) and the second region (220).

The elastic guard may include guard pins or other guard patterns or plain shapes and is not limited to pulling the skin during hair cutting.

Guard pins may protrude from the elastic guard and can provide a comfortable touch to the user while assisting in pulling the skin. While guard pins may extend longitudinally, the disclosure is not limited to this arrangement; for example, guard pins may extend transversely, diagonally, or may have a pillar shape.

The first functional unit (230) is located in an area where the second longitudinal length (L2) is formed, allowing more extensive contact with the user's skin.

The second functional unit (240) may perform similar or different functions compared to the first functional unit (230) and is located on a portion of the second region (220), including configurations like an elastic guard, guard pins, a lubricating band, a comb, or a scrubber. Thus, both the first functional unit (230) and the second functional unit (240) may be formed in the second region (220).

In this case, the elastic guard may include guard pins or other patterns or plain shapes and is not limited to pulling the skin during hair cutting.

Furthermore, the functional unit (200) may include a support (260) located below the first functional unit (230) (in the positive z-axis direction of FIG. 3), which supports the first functional unit (230).

The longitudinal ends of the support (260) may have the same shape as the longitudinal ends of the first functional unit (230) when viewed from above the razor cartridge (10). Thus, the longitudinal ends of the support (260) may be in line with the longitudinal ends of the first functional unit (230) when viewed from above the razor cartridge (10).

Therefore, the first functional unit (230) can be stably supported by the support (260) from below, ensuring seamless contact with the user's skin during shaving. Additionally, the support (260) does not extend beyond the first functional unit (230) longitudinally when viewed from above the razor cartridge (10), thus enhancing the skin irritation reduction and shaving experience through its curved and/or straight sections.

However, the razor cartridge (10) according to the present disclosure is not limited to this configuration, and the design may allow the first functional unit (230) to extend beyond the support (260) longitudinally or for the support (260) to extend beyond the first functional unit (230) longitudinally when viewed from above.

Referring to FIG. 3, the second functional unit (240) may include a scrubber capable of removing dead skin during shaving, which can be located at the longitudinal center of the second region (220). The scrubber may include a material harder than the elastic guard and can be manufactured by injection molding. In this case, the scrubber may have a three-dimensional surface roughness (SA) ranging from 20 μm to 200 μm, although the manufacturing method and roughness size of the scrubber are not limited to these parameters. The third functional unit (250) may perform similar or different functions compared to the first functional unit (230) and the second functional unit (240), located partially on the first region (210), and include configurations such as an elastic guard, guard pins, a lubricating band, a comb, or a scrubber. Therefore, the first region (220) may contain the first functional unit (230) and the third functional unit (250).

According to FIG. 3, the third functional unit (250) may include a comb that aligns the hair during shaving, positioned at the longitudinal center of the first region (210). Specifically, the comb may have multiple projections arranged repeatedly in a longitudinal pattern. These projections can contact the skin, reducing irritation caused by the blade (120) and aligning the hair as it passes between the projections, thus reducing undesirable tugging and improving the shaving experience.

The razor cartridge (10) according to this embodiment may include the functional unit (200) comprising the first functional unit (230), the second functional unit (240), and the third functional unit (250), but it may also not include the third functional unit (250) or may include additional functions.

Referring to FIG. 3, the razor cartridge (10) may include a side washing hole (160). The side washing hole (160) is located on a portion of the third region (130).

The side washing hole (160) can be formed as a hole that exposes the blade (300) on both sides of the third region (130).

The side washing hole (160) can facilitate the washing of the blades (300) inside the blade housing (100) via the washing water entering through the blade window (120) and then being discharged outside the blade housing (100).

Additionally, the side washing hole (160) can allow the washing water to enter the blade housing (100) from one side of the third region (130), wash the blade (300), and then be discharged outside the blade housing (100) from the other side of the third region (130).

By this process, the side washing hole (160) can facilitate the easy cleaning of the blade (300) located inside the blade housing (100) with the washing water.

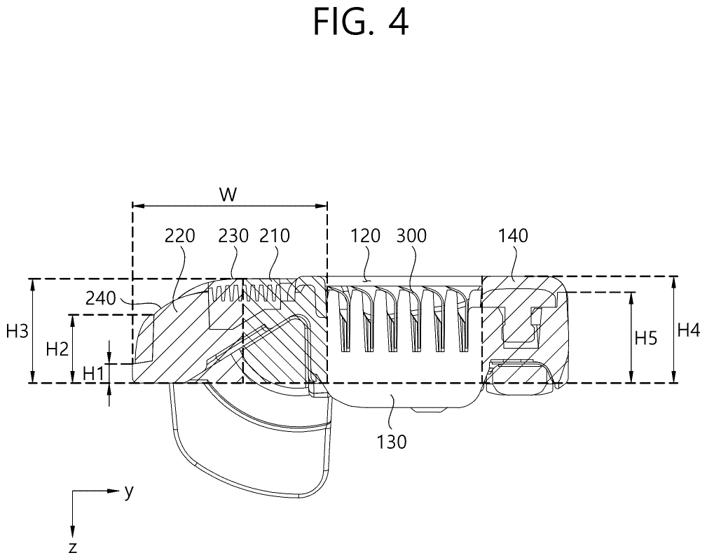

FIG. 4 is a cross-sectional view along section I-I′ shown in FIG. 3 of a razor cartridge according to an embodiment of the present disclosure.

Referring to FIG. 4, the transverse length (W) from the very front of the blade housing (100) to the cutting edge of the foremost blade (300) may range from 6.2 mm to 9.4 mm, preferably between 6.8 mm and 8.2 mm.

Additionally, as seen in FIG. 4, the vertical height (H1) at the transverse end of the functional unit (200) may range from 0.60 mm to 0.92 mm, ideally between 0.70 mm and 0.81 mm. Here, the vertical direction refers to the height direction of the razor cartridge (10), which could be parallel to the z-axis in FIG. 4.

The vertical height (H2) at the transverse end of the first functional unit (230) may range from 2.2 mm to 3.3 mm, preferably between 2.5 mm and 3.0 mm.

The third height (H3), which is the vertical length at the boundary between the first region (210) and the second region (220), could represent the maximum height of the functional unit (200). This third height (H3) may vary from 3.1 mm to 4.8 mm, ideally between 3.6 mm and 4.2 mm.

With such a configuration where the third height (H3) is the maximum height of the functional unit (200), a larger area of the razor cartridge (10) can contact the user's skin during shaving, reducing irritation and enabling a smoother shave.

That is, as one moves rearward on the second region (220), the height of the razor cartridge (10) progressively increases, allowing the upper surface of the razor cartridge (10) to contact the user's skin more stably and smoothly during shaving.

Furthermore, referring to FIGS. 2 and 4, the razor cartridge (10) according to the present disclosure can have the maximum height, the third height (H3), and the maximum longitudinal length, the second longitudinal length (L2), formed at the same location.

This structural arrangement allows users to more easily grasp both sides of the razor cartridge (10) through this specific location.

The specific location is spaced a certain distance from the blade (300), allowing users to handle the razor cartridge (10) with more confidence and reduced risk of cutting.

However, the maximum height of the razor cartridge (10) may not necessarily be the third height (H3) but could be the vertical height (H4) in the fourth region (140) of the blade housing (100).

This fourth height (H4) may range from 3.4 mm to 5.2 mm, ideally between 4.0 mm and 4.6 mm.

Referring to FIG. 4, the fifth height (H5), which is the height at the start of the steep slope formed on the fourth region (140) as one moves rearward, may range from 2.8 mm to 4.3 mm, preferably between 3.3 mm and 4.0 mm.

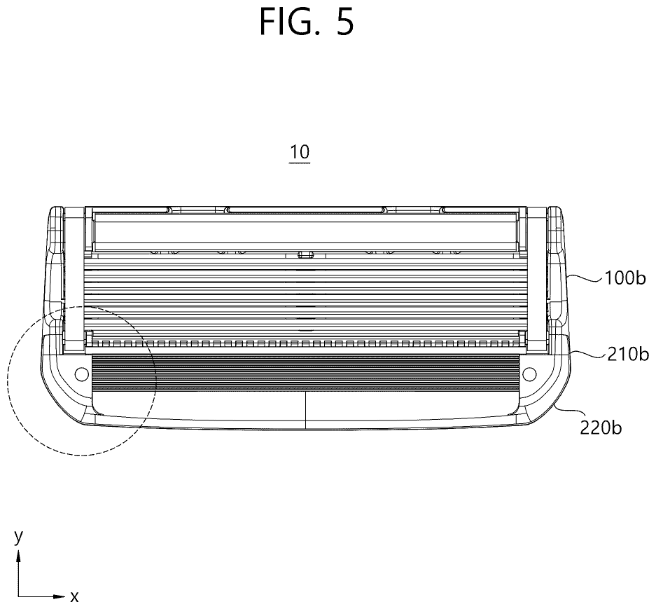

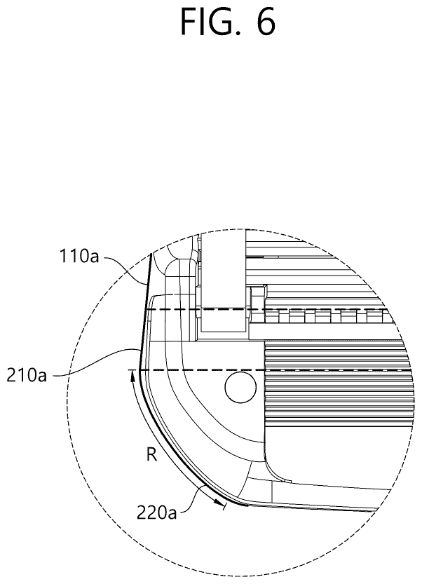

FIG. 5 is a top view of a razor cartridge according to an embodiment of the present disclosure, and FIG. 6 is an enlarged view of a portion indicated in FIG. 5.

Referring to FIGS. 5 and 6, in the razor cartridge (10) according to an embodiment of the present disclosure, the longitudinal ends (100a, 100b) of the blade housing (100) may include sections made of straight and/or curved lines.

More specifically, the spacing between the straight sections may narrow towards the rear of the blade housing (100) at its longitudinal ends (100a, 100b).

Each longitudinal end (210a, 210b) of the first region (210) may include straight sections.

Additionally, the spacing between the straight sections at the longitudinal ends (210a, 210b) of the first region (210) may narrow towards the rear of the first region (100).

Referring to FIGS. 5 and 6, the longitudinal end (100a) of the blade housing (100) and the longitudinal end (210a) of the first region (210) can join with the same slope at their boundary.

Similarly, the other longitudinal end (100b) of the blade housing (100) and the longitudinal end (210b) of the first region (210) can also connect at their boundary with the same slope.

The longitudinal ends (220a, 220b) of the second region (220) may be designed such that the longitudinal length of the razor cartridge (10) at the boundary between the first region (210) and the second region (220) is maximized.

When the longitudinal length of the razor cartridge (10) is maximized at the boundary between the first region (210) and the second region (220), as described above, users can hold the razor cartridge (10) more securely.

Additionally, the longitudinal ends (220a, 220b) of the second region (220) may include curved sections (R).

Each curved section (R) may be formed convexly outward and may also be formed with a consistent curvature. These curved sections (R) may smooth the shaving experience and reduce the irritation transmitted to the skin.

Furthermore, due to the curved sections (R), users can hold the razor cartridge (10) more smoothly and stably at the boundary between the first region (210) and the second region (220), where the longitudinal length of the razor cartridge (10) is maximized.

The angle of the curved sections can range from 27.2 degrees to 40.8 degrees, ideally between 30.6 degrees and 37.4 degrees. The radius of curvature can range from 38 mm to 51 mm, preferably between 40 mm and 49 mm.

The razor cartridge (10) according to this disclosure can undergo structural changes to reduce the irritation caused to the user's skin during shaving.

Additionally, the razor cartridge (10) according to this disclosure can enlarge the size of the functional unit (200) to perform more functions on the user's skin during the shaving process.

It will be apparent to those skilled in the art that the present disclosure can be embodied in many other specific forms without departing from the spirit or scope of the disclosure. Therefore, the present embodiments should be considered in all respects as illustrative and not restrictive. The scope of the disclosure is indicated by the appended claims rather than by the foregoing description, and all changes or modifications derived from the meaning and range of equivalency of the claims are intended to be embraced therein.

What is claimed is:

1. A razor cartridge configured to be connected with a razor handle, comprising:
at least one blade with a cutting edge;
a blade housing accommodating the blade in a longitudinal direction, the blade housing comprising a blade window exposing at least a part of the cutting edge;
a first region located in front of the blade housing, where a longitudinal length of the razor cartridge increases progressively from rear to front; and
a second region located in front of the first region, where the longitudinal length of the razor cartridge decreases progressively from rear to front,
wherein a ratio of a transverse length of the second region to a transverse length of the first region is in a range of 1 and 2.

2. The razor cartridge of claim 1, wherein the razor cartridge has a maximum longitudinal length of the razor cartridge at a boundary between the first region and the second region.

3. The razor cartridge of claim 1, wherein a longitudinal length at a rear end of the blade housing is longer than a longitudinal length at a front end of the second region.

4. The razor cartridge of claim 2, wherein the maximum longitudinal length ranges between 33 mm and 50 mm.

5. The razor cartridge of claim 2, wherein the maximum longitudinal length ranges between 37 mm and 46 mm.

6. The razor cartridge of claim 1, further comprising a first functional unit located at least partially on the first region and at a boundary between the first region and the second region.

7. The razor cartridge of claim 6, wherein the first functional unit includes at least one of an elastic guard, guard pins, a lubricating band, a comb, or a scrubber.

8. The razor cartridge of claim 6, further comprising a second functional unit located at least partially on the second region and configured to perform a function different from the first functional unit.

9. The razor cartridge of claim 8, wherein the second functional unit includes at least one of an elastic guard, guard pins, a lubricating band, a comb, or a scrubber.

10. The razor cartridge of claim 1, wherein a ratio of a transverse length of the second region to a transverse length of the first region is in a range of 1.25 and 1.92.

11. The razor cartridge of claim 1, wherein a ratio of a transverse length of the second region to a transverse length of the first region is in a range of 1.36 and 1.84.

12. The razor cartridge of claim 1, wherein a transverse length of the second region is in a range of 3.6 mm and 5.5 mm.

13. The razor cartridge of claim 1, wherein a transverse length of the second region is in a range of 4.1 mm and 5.1 mm.

14. The razor cartridge of claim 1, wherein a ratio of an area of the first region and the second region to a total area of the razor cartridge is in a range of 0.5 and 0.85.

15. The razor cartridge of claim 1, wherein a ratio of an area of the first region and the second region to a total area of the razor cartridge is in a range of 0.6 and 0.75.

16. The razor cartridge of claim 1, wherein the blade housing includes a third region located laterally to the blade window and supporting the blade, and wherein the third region has a longitudinal length that progressively increases toward the front to connect with the first region.
